(19) United States
(12) Patent Application Publication
(10) Pub. No.: US 2011/0128511 A1
(43) Pub. Date: Jun. 2, 2011

(54) FOLDING-TYPE PORTABLE DEVICE

(75) Inventors: Jae-Woo KO, Uiwang-si (KR); Giu-Yeol KIM, Suwon-si (KR); Dong-Yun SHIN, Seongnam-si (KR); Hyun-Cheol PARK, Seoul (KR); Seoung-Bok LEE, Yongin-si (KR)

(73) Assignee: Samsung Electronics Co., Ltd., Gyeonggi-do (KR)

(21) Appl. No.: 12/956,847

(22) Filed: Nov. 30, 2010

(30) Foreign Application Priority Data
Nov. 30, 2009 (KR) 10-2009-0116645

(51) Int. Cl. G03B 21/30; G02B 7/02

(52) U.S. Cl. 353/119; 359/811

(57) ABSTRACT

Disclosed is a folding-type portable device. The folding-type portable device includes a first body having an abutment for cradling a portable terminal; a second body rotatably connected to the first body through a first hinge, so that the second body is folded or unfolded in relation to the first body, the second body being rotated to a predetermined angle in relation to the first body, thereby supporting the first body in a tilted state; and an optical module connected to the second body through a second hinge in such a manner that the optical module can be independently rotated, the optical module having a lens which is exposed or hidden depending on whether the optical module is rotated. The portable device may be used as an assistant portable device for extending functionality of a portable terminal.

### PRIORITY

This application claims priority under 35 U.S.C. §119(a) to a Korean Patent Application filed in the Korean Intellectual Property Office on Nov. 30, 2009 and assigned Serial No. 10-2009-0116645, the contents of which are incorporated herein by reference.

### BACKGROUND OF THE INVENTION

1. Field of the Invention

The present invention generally relates to a folding-type portable device, and more particularly to a folding-type portable device, which can be used for multiple purposes in multimedia environments as an assistant device for extending the functionality of a portable terminal, and which is convenient to carry.

2. Description of the Related Art

Due to the improvement of performance of portable terminals, including cellular phones, smart phones and the like, they are now used for various purposes, such as media reproduction and games. While starting from a mere telephone function or a short message transmission function, the functionality of the portable terminals are continually being extended. In order to increase the utilization of such portable terminals with the above-mentioned functions, various types of cradle devices have been produced commercially, and placed on the market.

Popular cradle devices have initially been used merely for cradling a portable terminal, and for charging a battery of such a portable terminal. However, such cradle devices have recently been provided with various communication and AV interfaces, and the functionality and utilization thereof are in the process of being gradually extended.

However, recent cradle devices are used in a state in which they are positioned in a stationary environment, for example adjacent to a TV, a PC (personal computer), or the like, wherein in order to support various kinds of portable terminals with different appearances, such a cradle device has a structure corresponding to a connector to be connected to the cradle device, wherein the structure can be structurally changed when the cradle device is used, or a separate cable is employed so as to cope with such a condition. A conventional cradle typically used in such a stationary environment will be described below.

FIG. 1 shows a conventional charging cradle 50 which has been widely used. As shown in FIG. 1, the charging cradle 50 includes a cradle body 51, a slot-shaped opening 52 for cradling a mobile communication terminal, the opening 52 being formed at a central area of the top side of the cradle body 51, and a protrusion-shaped connection part 53 provided on the bottom of the opening 52. The charging cradle 50 is used in such a manner that a portable terminal to be charged is connected to the connection part 53, and is charged in a state in which it is held in the connected and cradled state.

However, the conventional charging cradle is not only inconvenient to carry, but also inconvenient to use in various multimedia environments since it is merely a charging and cradling device.

In addition, such a fixed-type charging cradle is sufficient only for a charging or cradling function. Such a charging cradle has disadvantages in that it lacks portability and cannot actively cope with various requirements for satisfying multimedia environments, for example, a large capacity storage function, and an audio-visual environment, such as TV, Digital Multimedia Broadcasting (DMB) or the like.

### SUMMARY OF THE INVENTION

Accordingly, the present invention has been made to solve the above-mentioned problems occurring in the prior art, and the present invention provides a folding-type portable device which is superior in portability as compared to a conventional charging cradle, and which can actively cope with a user's stationary environment or a user's mobile environment so as to satisfy multimedia environmental requirements.

Also, the present invention provides a folding-type portable device to be used as an assistant device which is capable of extending the functionality of a portable terminal.

In addition, the present invention provides a folding-type portable device which is provided with an optical module in such a manner that the optical module can be rotated, so that contents of a portable terminal can be watched through a large screen.

In accordance with an aspect of the present invention, there is provided a folding-type portable device including a first body having an abutment for cradling a portable terminal; a second body rotatably connected to the first body through a first hinge, so that the second body is folded or unfolded in relation to the first body, the second body being rotated to a predetermined angle in relation to the first body, thereby supporting the first body in a tilted state; and an optical module connected to the second body through a second hinge in such a manner that the optical module can be independently rotated, the optical module having a lens which is opened or closed depending on whether the optical module is rotated or not.

The abutment extends from the first body, and a connection part may protrude from a face of the abutment so as to hold the portable terminal cradled on the abutment.

The second body has an opening for receiving the optical module, wherein the opening is opened at the top and bottom thereof.

The first hinge is a free stop hinge, and provides first and second hinge axes which are parallel to each other. In addition, the second hinge is also a free stop hinge, and provides a third hinge axis which is coaxial to the second hinge axis.

### BRIEF DESCRIPTION OF THE DRAWINGS

The above and other aspects, features and advantages of the present invention will be more apparent from the following detailed description taken in conjunction with the accompanying drawings, in which:

FIG. 1 is a perspective view showing a conventional charging cradle device;

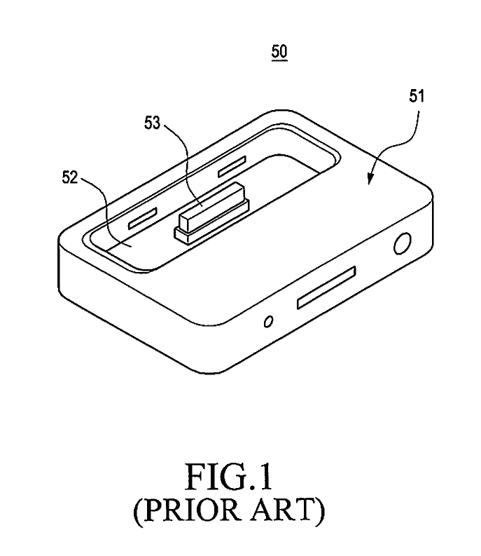

FIG. 2 is a perspective view showing a portable device in a folded state in accordance with an embodiment of the present invention;

FIG. 3 is a perspective view showing the portable device in an unfolded state; and

FIG. 4 is a side view showing the portable device in use.

### DETAILED DESCRIPTION OF EMBODIMENTS OF THE PRESENT INVENTION

With reference to accompanying drawings, an embodiment of the folding-type portable device will be described. The following detailed description includes specific details in order to provide a thorough understanding of the present invention. However, it will be apparent to those skilled in the art that the present invention may be practiced without such specific details. The same reference numerals refer to the same elements in the drawings.

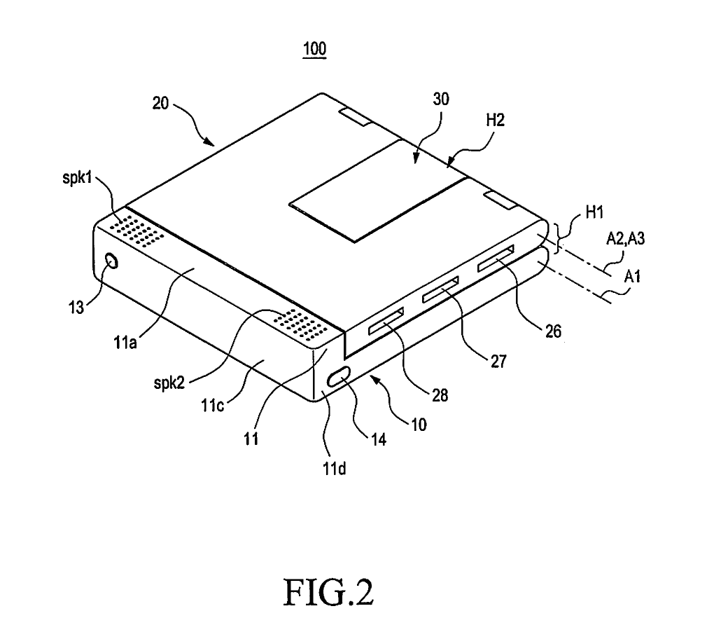

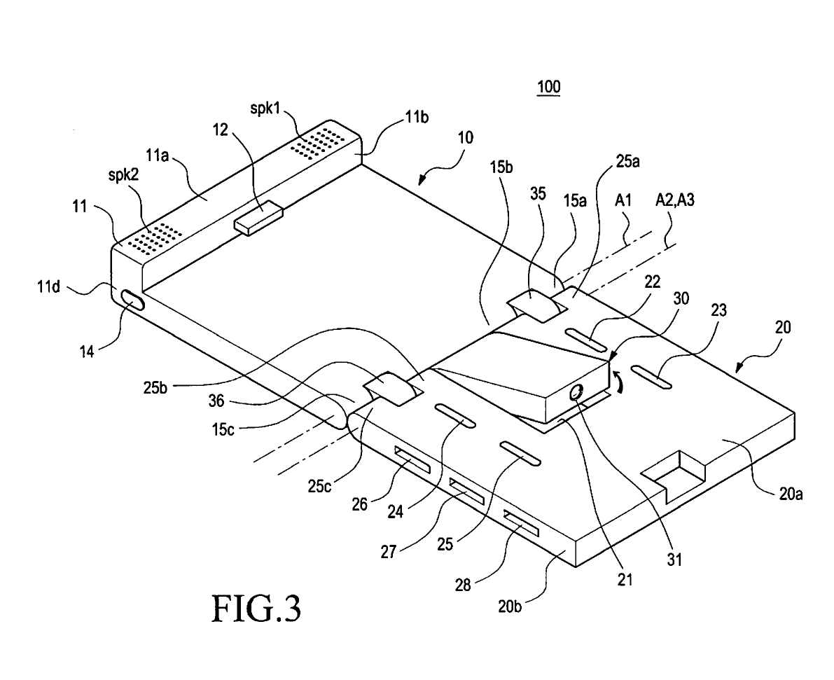

As shown in FIGS. 2 and 3, the folding-type portable device 100 is a device which may be carried together with a portable terminal which is always carried by a user, or a portable storage device, such as a memory card or a memory stick. In particular, the portable device 100 may be employed as an assistant device for projecting information displayed on the display unit of a portable terminal on a screen by being connected to the portable terminal, or may be employed as an assistant device for executing information stored in a portable storage device and projecting the executed information on a screen. In addition, the portable device may be employed as a large capacity storage device, and may be used as an assistant battery device. More particularly, it shall be noted that the portable device 100 can arrange one or more external interfacing devices on the portable device 100 so as to actively cope with either a mobile environment or a stationary environment.

As shown in FIGS. 2 and 3, the portable device 100 is of a folding-type which is advantageous in terms of miniaturization and slimming, and includes first and second bodies 10 and 20, a first hinge H1 for rotatably interconnecting the first and second bodies 10 and 20, and an optical module 30 rotatably connected to the second body 20 through a second hinge H2. The first body 10 is provided with an abutment 11, on which a portable terminal is cradled and connected. The abutment 11 extends vertically from the first body 10 in a form of a protrusion. In addition, the abutment 11 is provided with a connection part 12 protruding from a vertical face 11b of the abutment 11. The connection part 12 is inserted into a counterpart connection part of a portable terminal (not shown in the drawings), and electrically connected to the optical module 30 through a flexible printed circuit board (not shown in the drawings). The optical module 30 will be described in detail below. Being connected to the counterpart connection part of the cradled portable terminal, the connection part 12 holds the portable terminal in a mounted position on the portable device 100.

The abutment 11 is provided with left and right speakers spk 1 and spk 2, which are arranged opposite to each other on the front side 11a of the abutment 11, so that the speakers spk1 and spk 2 can provide stereo sound to the user. In addition, the abutment 11 is also provided with an earphone jack connection terminal 13 on its bottom side 11c, and a power switch 14 on its lateral side 11d. The top and bottom sides of the first body 10 are flat.

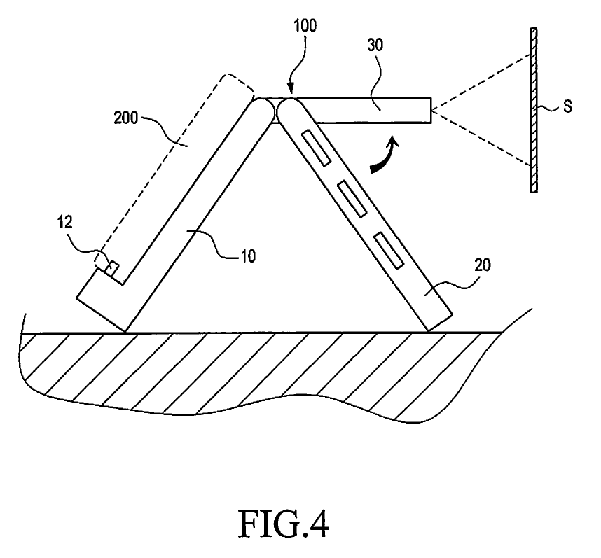

The second body 20 is rotatably connected to the first body 10 through the first hinge H1, so that the second body 20 can be folded or unfolded in relation to the first body 10. FIG. 2 shows the portable device 100 in the folded state, and FIG. 3 shows the portable device 100 in the unfolded state. The rotation angle of the second body 20 in FIG. 3 is about 180 degrees, although as shown in FIG. 4, the second body 20 can rotate up to about 360 degrees.

As shown in FIGS. 3 and 4, the second body 20 is rotated in a predetermined angle in relation to the first body 10, thereby supporting the first body 10 in a tilted state. The second body 20 is provided with a slot-shaped opening 21, wherein the opening 21 receives the optical module 30 when the optical module 30 is in the folded state. The opening 21 is opened at the top and bottom sides thereof, and has a shape corresponding to the external appearance of the optical module 30. The optical module has a lens 31 which is protected when the optical module 30 is folded into the opening 21, and is positioned in a usable condition when the optical module 30 is unfolded. That is, the lens is exposed or hidden depending on whether the optical module 30 is rotated or not.

The second body 20 is provided with external interfacing devices: a speaker switch 22 and a TV switch 23, which are positioned adjacent to one lateral side of the optical module 30; and a volume control button 24 and a brightness control button 25, which are positioned adjacent to the other lateral side of the optical module 30. In addition, the second body 20 is provided with a plurality of ports on a lateral side 20b thereof: port 26 is preferably for a USB connection for a PC, for example, while port 27 is preferably for a USB for a Digital Still Camera (DSC), and remaining port 28 is for an HDMI terminal. The use conditions of the external interfacing devices can be separated into two cases: one case in which they are used in a mobile environment, and the other case in which they are used in a stationary environment, the arrangement of the external interfacing devices provided on the second body 20 may be determined so as to provide convenience for each of the use conditions. The mobile environment means a portable terminal's environment when a user carries the portable terminal, and the stationary environment means a portable terminal's environment when the user stays at a company, an office or the like.

In the mobile environment, the portable device 100 is mainly carried by the user in the folded state. Therefore, it is desirable to arrange at least two ports on the above-mentioned lateral side 20b of second body. In the stationary environment, the portable device is apt to be in the unfolded state. Therefore, it is desirable to arrange at least two switches, such as the TV switch 22, on the inner face 20a of the second body 20, wherein the inner face 20 means a face of the main body which comes into contact with the first body 10 and is not exposed to the outside when the portable device 100 is in the folded state.

If the portable device 100 is in a large capacity storage mode in the mobile environment where it is being carried by the user, the portable device 100 and the portable terminal 200 (see FIG. 4) are preferably interconnected with a USB cable, wherein if the portable terminal 200 is a host, it is possible to download contents or data stored in the large capacity storage device of the portable device 100, in such a manner that the contents or data can be used by being reproduced and edited by the portable terminal 200. It is also possible to use the portable device 100 as a local memory or a backup device of the portable terminal 200.

In a stationary environment, such as a home or an office, if the portable device 100 with a cradled portable terminal is connected to a TV through a cable, it is possible to watch the contents of the portable terminal through a large TV screen while reproducing and editing the contents. It is also possible to reproduce and watch the contents of the portable terminal through the optical module provided in the portable device. In such a stationary environment, internal interfacing devices including at least two switches may be used, wherein the internal interfacing devices are provided on the inner face 20a of the second body.

If the battery of the portable terminal is completely consumed, a built-in type battery (not shown) housed within the portable device 100 may temporarily serve as an auxiliary battery to operate the portable terminal, or the portable device 100 may be used as an assistant input means for the portable terminal by connecting a USB assistant device, such as a DSC or a keyboard.

As shown in FIG. 3, the optical module 30 is rotatably connected to the second body 20, wherein the second hinge H2 is positioned at one end of the optical module 30, and an optical lens 31 is mounted on the other end of the optical module 30. Since the optical module 30 is configured as a projector, information may be projected through the lens 31. The projected information can be visibly displayed on a screen S, as shown in FIG. 4.

As shown in FIGS. 2 and 3, the first hinge H1 rotatably connects the second body 20 to the first body 10, wherein the first hinge H1 provides first and second hinge axes A1 and A2, which are parallel to each other. The first hinge H1 is configured as a free stop hinge. The free stop hinge means a hinge which can be rotated 360 degrees and can provide force for stopping at any desired rotation angle.

The first hinge H1 includes a plurality of hinge arms 15a, 15b and 15c; 25a, 25b and 25c, which are provided in the first and second bodies, respectively, and two dual hinge members 35 and 36. One end of each of the dual hinge members 35 and 36 is coupled to the hinge arms 15a, 15b and 15c with reference to the first hinge axis A1, and the other end is coupled to the hinge arms 25a, 25b and 25c with reference to the second hinge axis A2. In addition, dual hinge members 35 and 36 are symmetrically arranged along the first and second hinge axes A1 and A2, respectively.

The second hinge H2 rotatably connects the optical module 30 to the second body 20, wherein the second hinge H2 is configured as a free stop hinge. The free stop hinge means a hinge which can be rotated 360 degrees, wherein the second hinge H2 can provide force for retaining the stopped state of the optical module 30 when the optical module 30 stops rotation at any desired rotation angle. In addition, the second hinge H2 connects the optical module 30 to the second body 20 to be rotatable about a third hinge axis A3, which is coaxial to the second hinge axis A2. A flexible printed circuit board (FPCB) (not shown) may be employed so as to electrically interconnect the first and second bodies 10 and 20. The FPCB extends through the first and second hinge parts.

FIG. 4 shows the portable device 100 placed in a stationary environment, for example located on a desk at a home or an office. In particular, FIG. 4 shows a state in which information projected from the optical module 30 is displayed on the screen S after the portable terminal 200 is cradled on and connected to the portable device. If the second body 20 is rotated to a predetermined angle in a state in which the portable terminal 200 is connected to the connection part 12 of the first body 10, the first body 10 is supported by the second body 20 in the tilted state. Next, if information transmitted to the optical module 30 is projected on the screen S after the optical module 30 is rotated to a predetermined angle, and the optical module 30 is fixed and oriented toward the screen S, the contents stored in the portable terminal 200 are displayed on the display unit of the portable terminal, and then the information displayed on the display unit is displayed on the screen S. Consequently, the portable device can perform a role as a compact projector for a portable terminal.

While the invention has been shown and described with reference to certain embodiments thereof, it will be understood by those skilled in the art that various changes in form and details may be made therein without departing from the spirit and scope of the invention as defined by the claims.

What is claimed is:

1. A folding-type portable device comprising:
a first body having an abutment for cradling a portable terminal;
a second body rotatably connected to the first body through a first hinge, so that the second body is folded or unfolded in relation to the first body, the second body being rotated to a predetermined angle in relation to the first body, thereby supporting the first body in a tilted state; and
an optical module connected to the second body through a second hinge in such a manner that the optical module can be independently rotated, the optical module having a lens which is exposed or hidden depending on whether the optical module is rotated.

2. The folding-type portable device as claimed in claim 1, wherein the abutment extends from the first body, and a connection part protrudes from a face of the abutment so as to hold the portable terminal cradled on the abutment.

3. The folding-type portable device as claimed in claim 1, wherein left and right speakers are provided on a front side of the abutment, thereby providing stereo sound.

4. The folding-type portable device as claimed in claim 2, wherein the optical module is configured as a projector.

5. The folding-type portable device as claimed in claim 1, wherein the second body has an opening for receiving the optical module, the opening being opened at the top and bottom thereof.

6. The folding-type portable device as claimed in claim 1, wherein the first hinge is configured as a free stop hinge, and provides first and second hinge axes which are parallel to each other, and the second hinge is configured as a free stop hinge, and provides a third hinge axis which is coaxial to the second hinge axis.

7. The folding-type portable device as claimed in claim 1, wherein two or more switches are provided on an inner face of the second body, the switches being used in a stationary environment, and two or more ports are provided on one lateral side of the second body, the ports being used in a mobile environment.
